(19) United States
(12) Patent Application Publication
(10) Pub. No.: US 2012/0262720 A1
(43) Pub. Date: Oct. 18, 2012

(54) OPTICAL COHERENCE TOMOGRAPHY IMAGING SYSTEM

(76) Inventors: William J. Brown, Durham, NC (US); Michael E. Sullivan, Raleigh, NC (US)

(21) Appl. No.: 13/267,574

(22) Filed: Oct. 6, 2011

Related U.S. Application Data
(60) Provisional application No. 61/390,274, filed on Oct. 6, 2010.

(51) Int. Cl. G01J 3/45; G01B 9/02

(52) U.S. Cl. 356/453; 356/456

(57) ABSTRACT

An optical coherence tomography (OCT) imaging system is disclosed. In an embodiment of the invention, an OCT imaging system may include (a) multiple scan geometries, including a lateral scan of a beam perpendicular to the scan direction and a rotating scan where the beam is perpendicular to a curved surface (such as the front of the eye), and (b) a low coherence interferometry engine based on spectral domain interferometry, with a spectrometer capable of ultra deep imaging.

### PRIORITY CLAIM

This application claims the benefit of U.S. Provisional Patent Application No. 61/390,274, filed Oct. 6, 2010, for an “Optical Coherence Tomography Imaging System,” with inventors William J. Brown and Michael E. Sullivan.

### TECHNICAL FIELD

The present disclosure relates generally to the field of optical coherence tomography (OCT).

### SUMMARY

An optical coherence tomography (OCT) imaging system is disclosed. In an embodiment of the invention, an OCT imaging system may include (a) multiple scan geometries, including a lateral scan of a beam perpendicular to the scan direction and a rotating scan where the beam is perpendicular to a curved surface (such as the front of the eye), and (b) a low coherence interferometry engine based on spectral domain interferometry, with a spectrometer capable of ultra deep imaging. In an embodiment of the invention, imaging depths of as much as approximately 10 mm in air and/or approximately 7 to 8 mm in tissue can be achieved with the scan speed and resolution of a typical spectral domain retinal scanning system.

There are many potential applications for an OCT imaging system in accordance with an embodiment of the invention. Examples of potential applications include imaging translucent samples, such as the anterior segment of the eye or the lens of the eye, as well as industrial applications such as quality control in glass, plastic, or other types of structures.

### BRIEF DESCRIPTION OF THE DRAWINGS

FIG. 1 illustrates an OCT imaging system in accordance with an embodiment of the invention;

FIGS. 2A and 2B illustrate an implementation of the scan optics in the OCT imaging system of FIG. 1;

FIG. 3 illustrates an implementation of the lateral scan optics shown in FIG. 2A;

FIG. 4 illustrates lenses that implement the curved scan optics shown in FIG. 2B;

FIG. 5 shows a potential image of the anterior segment of an eye using the curved scan optics;

FIG. 6 illustrates an implementation of the interferometry engine in the OCT imaging system shown in FIG. 1;

FIG. 7 illustrates an implementation of the spectrometer in the interferometry engine shown in FIG. 6; and

FIG. 8 shows some of the attributes of an OCT imaging system in accordance with an embodiment of the invention compared with other OCT imaging systems.

FIG. 9 illustrates an image of a human cornea that was taken by an OCT imaging system in accordance with an embodiment of the invention.

FIG. 10 illustrates an image of an entire human lens that was taken by an OCT imaging system in accordance with an embodiment of the invention.

### DETAILED DESCRIPTION

Optical coherence tomography was first developed in the early 1990s and is now an established imaging modality with numerous medical applications and some uses in industry. The primary market remains retinal imaging of the human eye and there are several companies offering products for this application. The next two emerging medical markets for OCT are intravascular OCT (IV-OCT) and anterior segment OCT (AS-OCT). IV-OCT is used to image the walls of blood vessels inside the body to help identify unstable plaques, stent placement, stent performance over time and other vascular conditions. IV-OCT is currently implemented using swept source systems at 1310 nm.

AS-OCT is used for a number of imaging applications including pre-operative and post-operative evaluation of LASIK, corneal tears, bruises, scars or ulcers, angle measurement in glaucoma patients, cataract surgery, trauma surgery and others. To date for AS-OCT there have been two approaches to system design. The first is to use time domain OCT which provides good imaging depth, but has poor imaging speed and resolution. The second is to modify a retinal system by adding additional lens elements so that the beam is focused on the front of the eye instead of entering the pupil as a collimated beam as is needed for retinal imaging. This approach provides the speed and resolution associated with retinal imaging, but is limited in imaging depth to 2-3 mm which is insufficient to image the entire anterior chamber. These systems are used primarily to look at just the front of the cornea or to look at the angle where the cornea connects with the iris.

An OCT imaging system in accordance with an embodiment of the present invention may overcome the shortcomings of the current approaches to anterior segment imaging by using an ultra-deep imaging spectral domain system. However, the scope of the embodiments disclosed herein are not limited to anterior segment imaging.

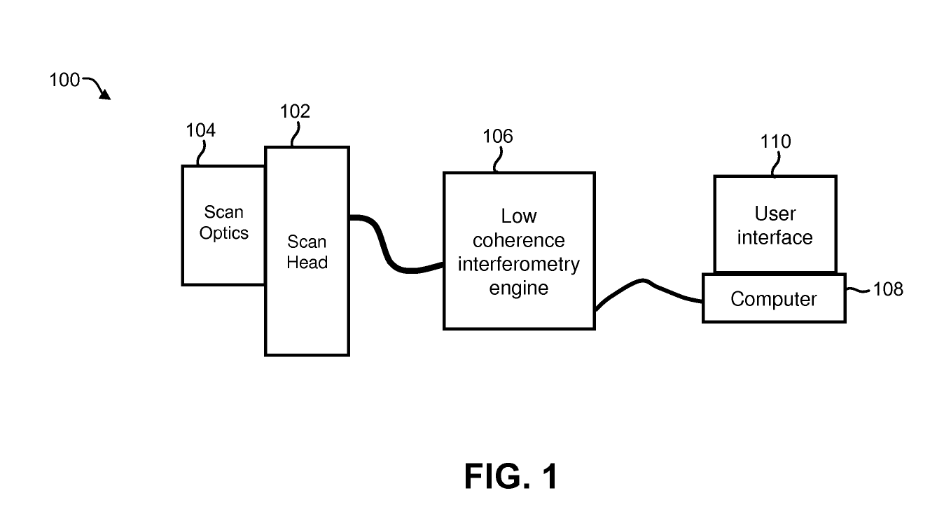

FIG. 1 illustrates an OCT imaging system 100 in accordance with an embodiment of the invention. The sub-systems within the OCT imaging system 100 include a scan head 102, scan optics 104 connected to the scan head 102, a low coherence interferometry engine 106 (which may alternatively be referred to as an OCT engine), a computer 108, and a user interface 110. The user interface 110 may include a display screen as well as one or more input devices (e.g., a mouse, keyboard, touchpad, touchscreen, trackball, etc.) for receiving user input. Various implementations of these sub-systems will be described below.

In FIG. 1, the sub-systems are shown as separate blocks for ease of understanding. However, the system 100 may be built in a single unit or multiple units based on customer needs, system complexity and cost.

Scan Geometries

One potential application of the OCT imaging system 100 is to image the anterior segment of an eye, which includes the cornea. The OCT imaging system 100 may have at least two interchangeable scan geometries. If the system 100 is being used for imaging the anterior segment of an eye, these scan geometries may optimized for different types of imaging of the cornea and the anterior segment. The scan geometries will be referred to as “lateral scanning” and “curved scanning.”

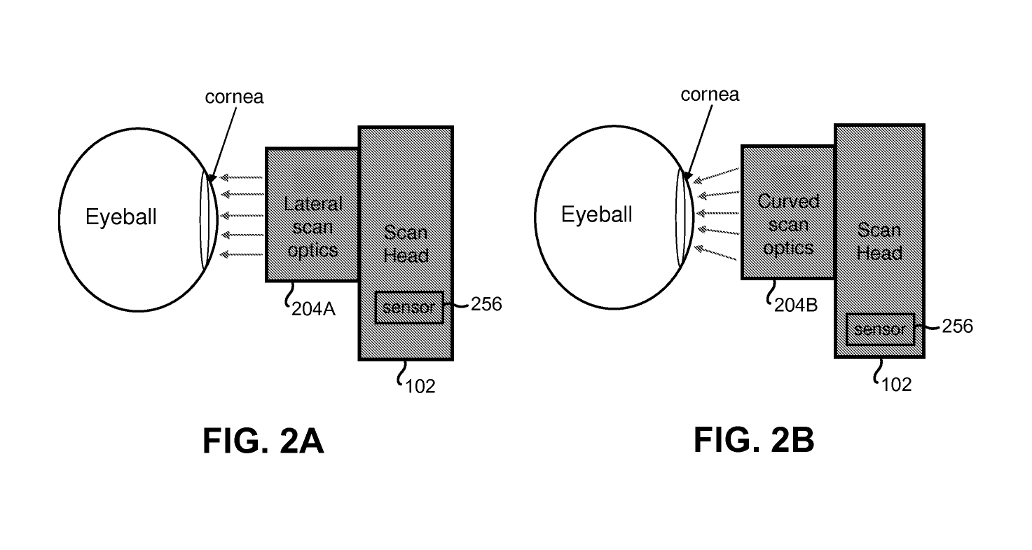

FIGS. 2A and 2B illustrate an implementation of the scan optics 104 in the OCT imaging system 100 of FIG. 1. This implementation includes lateral scan optics 204A and curved scan optics 204B that are interchangeably connectable to the scan head 102. In other words, either the lateral scan optics 204A or the curved scan optics 204B may be used with the same scan head 102. Users may easily be able to swap one set of optics for the other based on their imaging needs.

The scan head 102 and the lateral scan optics 204A facilitate lateral scanning, i.e., moving a focused beam back and forth in a direction that is perpendicular to the beam itself. The scan head 102 and the curved scan optics 204B facilitate curved scanning, i.e., moving a beam across a curved surface (e.g., the cornea of an eye) such that the beam remains perpendicular or close to perpendicular relative to the curved surface.

The scan head 102 may be based on any number of technologies including galvonometer mirrors, micro-electro-mechanical systems (MEMS) mirrors, etc. The interface between the scan head 102 and the interferometry engine 106 may include one or more optical connections and one or more control lines for scanners.

The scan head 102 may include a sensor 256 that automatically detects which set of optics is attached. The sensor 256 may be mechanical, electrical, electronic, optical, or some combination thereof. The sensor 256 may also be able to verify that the scan optics are in the correct position and/or are locked in place. This information may also be used to automatically adjust other aspects of the system including the optical path length of the reference arm, the polarization controller, the software interface, the image display, and/or other system characteristics.

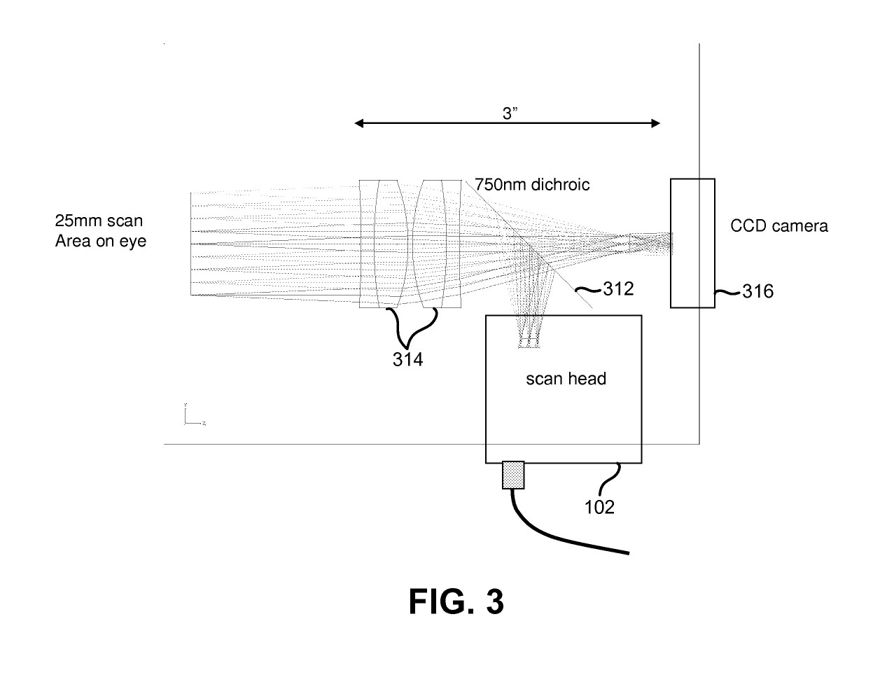

FIG. 3 illustrates an implementation of the lateral scan optics 204A shown in FIG. 2A. This implementation includes a dichroic 312, lenses 314, and a camera 316.

The scan head 102 changes the path of the light beam (which may originate in the interferometry engine 106, as will be explained below) by using one or more movable mirrors. These mirrors may be located inside the scan head 102. The mirrors may be, for example, of the galvonometer type (i.e., mounted to an electric galvonometer motor and rotated about the axis of the motor) or the micro-electro-mechanical systems (MEMS) type. Galvonometer mirrors provide one degree of freedom per motor, so two motors may be required to scan across the sample. MEMS mirrors may have one degree or two degrees of freedom, so a full scanner may be built with either two MEMS mirrors or one MEMS mirror.

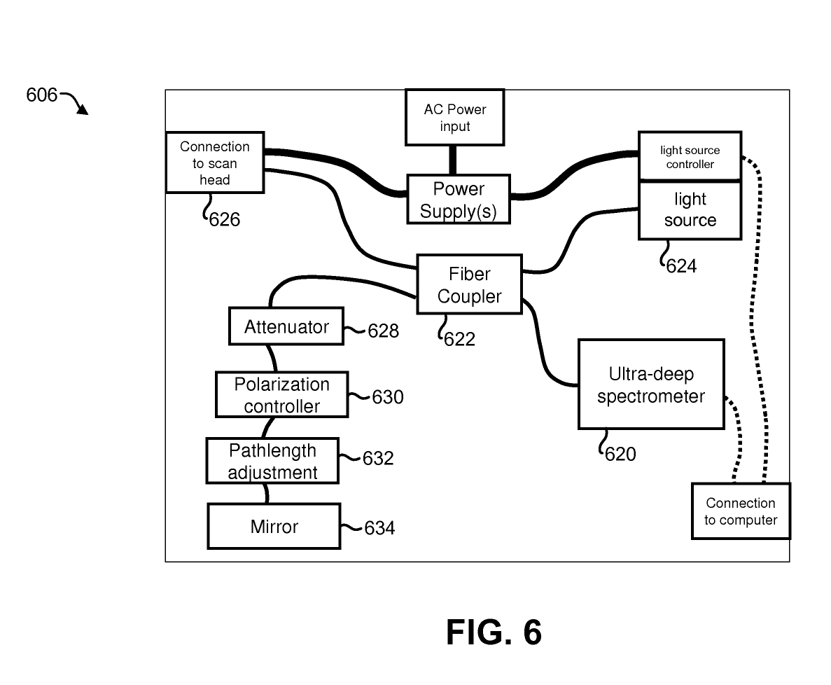

In one example, the dichroic 312 allows light with a wavelength shorter than 750 nm (“visible light”) to pass through, while reflecting light with a wavelength longer than 750 nm. A light source (e.g., the light source 624 shown in FIG. 6) that emits light having a wavelength of 800 nm to 880 nm may be used in the existing implementation. This can be done with other wavelength combinations, including (1) a dichroic around 900 nm, using visible for imaging (i.e., taking a picture with a CCD or CMOS camera, so that the location of the OCT beam may be coregistered with the visible picture) and 1000 nm to 1100 nm for OCT, (2) a dichroic between the visible (e.g., roughly 400 nm to 700 nm) and an OCT wavelength around 1310 nm, (2) a dichroic between the visible and an OCT wavelength of 1550 nm.

The lenses 314 set the type of scanning done by the mirror(s). The camera 316 may be a visible or NIR camera that allows imaging of the sample while taking OCT images. If the OCT wavelength bleeds through the dichroic 312 a little bit, it may be possible to see the location of the OCT beam in the visible, surface image.

Although FIG. 3 shows one-dimensional scanning, scanning may occur in one dimension or two dimensions. There are many different scan patterns that may be used, including a line scan, a radial scan, a circular scan, a three-dimensional volume scan, etc.

An alternative implementation of the lateral scan optics 204A may not include the dichroic 312 or the camera 316.

If the OCT imaging system 100 is being used to image the anterior segment of an eye, then the focusing of the beam should provide a depth of field that is on the order of the imaging depth needed for the anterior segment (e.g., five or six millimeters). The scan range can be from a few millimeters up to 25 millimeters or more.

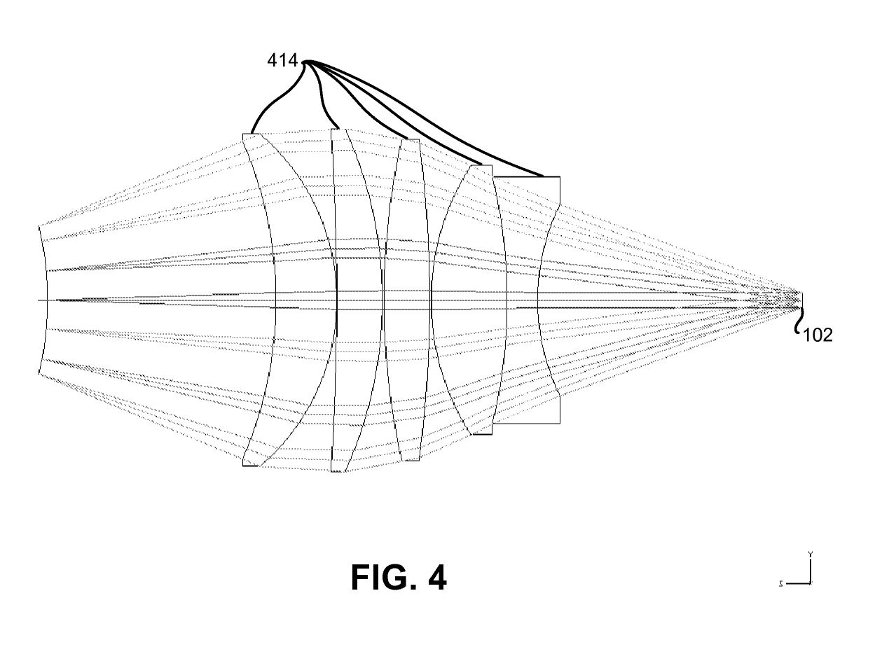

FIG. 4 illustrates lenses 414 that implement the curved scan optics 204B shown in FIG. 2B.

The beam may be exactly perpendicular or close to perpendicular, depending on which gives the best image properties. An exactly perpendicular beam may generate too much specular reflected light, potentially saturating the system or obscuring features deeper in the sample. One solution would be to have the beam close to perpendicular (i.e., within plus or minus five degrees) so that specular light is minimized while maintaining the advantages of normal incidence.

Scanning may occur in one dimension or two dimensions. There are many different scan patterns that may be used, including a line scan, a radial scan, a circular scan, a three-dimensional volume scan, etc.

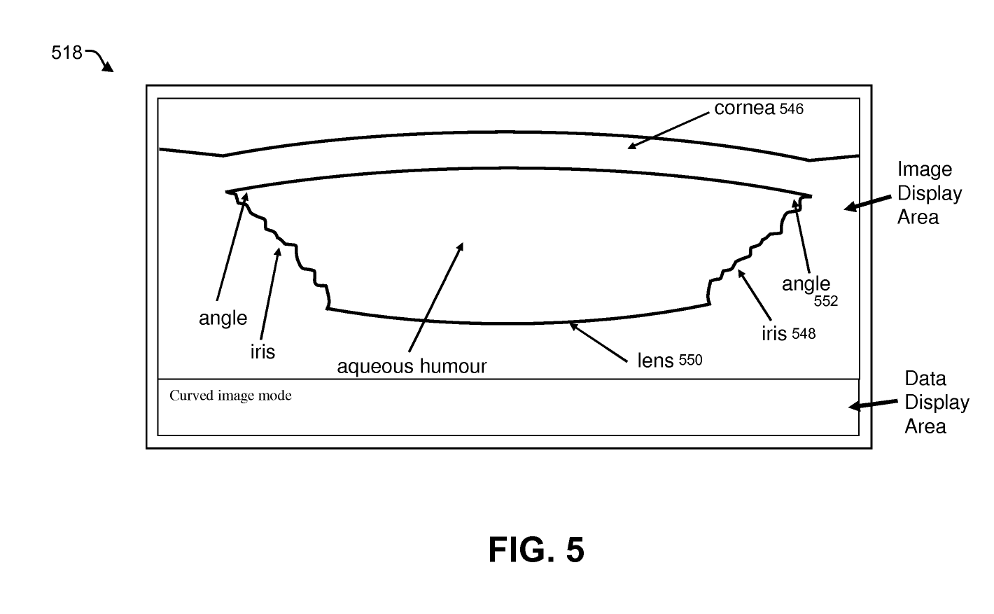

If curved scanning is used for imaging the anterior segment of an eye, this may provide an OCT image of the cornea that looks similar to the “flattened” image of the retina generated by retinal scanners. FIG. 5 shows a potential image 518 of the anterior segment of an eye using the curved scan optics 204B. The image 518 may be displayed via the user interface 110.

In the image 518, the front surface of the cornea 546 is flat, or nearly so. This may simplify and increase the accuracy of derived measurements including corneal flatness, corneal thickness and others. Instead of appearing nearly flat, the iris 548 descends into the image 518 at a significant angle. This configuration brings the angle 552 where the cornea 546 meets the iris 548 to a much shallower depth in the image 518 than in typical lateral scan images. This may improve the accuracy of the measurement of this angle 552. The lens 550 may appear distorted and may appear concave instead of convex. This is a consequence of the scan geometry since the scan beam is effectively rotating about a point behind the lens 550.

Image quality may potentially be improved relative to lateral scanning, since the front surface of the cornea will be at approximately the same depth in the OCT image at each scan point. In addition, information derived from the image 518 may be improved, such as the thickness of the cornea, the curvature of the cornea (both front and back), LASIK flap identification and measurement, measurement of the corneal angle, and any other derived metrics or images.

In particular, for angle measurement, curved scanning may produce superior results to lateral scanning, since the scanning beam will still be nearly perpendicular at point where the cornea 546 meets the rest of the eye. This may provide an improved light signal and since it will not be as deep in the image (compared to lateral scanning) the fall-off will not be as much of a factor.

Ultra-Deep Imaging

To date OCT systems capable of imaging more than a few millimeters in depth have been either time domain systems or swept source systems. As already noted, time domain systems have lower performance optical signal to noise ratios (OSNR) leading to slower scan speeds and lower resolution. Swept source systems take advantage of the improved OSNR from Fourier domain OCT, but high scan speed swept lasers are complex, potentially unstable and expensive systems.

FIG. 6 illustrates an interferometry engine 606 that is an implementation of the interferometry engine 106 in the OCT imaging system 100 shown in FIG. 1. The interferometry engine 606 is based on spectral domain interferometry. The interferometry engine 606 includes a very high resolution spectrometer 620 that is configured for ultra deep imaging. The term “ultra deep imaging” means imaging of at least 5 millimeters in air or at least 4 millimeters in tissue.

The interferometry engine 606 includes a fiber coupler 622. The fiber coupler 622 includes a port that is connected to a light source 624, which may be a superluminescent diode (SLD) or other broadband light source. The fiber coupler 622 also includes another port that is connected to the spectrometer 620, another port that is connected to the sample arm via a connection 626 to the scan head 102, and another port that is connected to the reference arm.

The reference arm contains the elements needed to match to the sample arm and control the power going back to the camera in the spectrometer 620. In the depicted implementation, the reference arm includes an attenuator 628, a polarization controller 630, a pathlength adjustment mechanism 632, and a mirror 634 or retroreflector.

In an alternative implementation of the interferometry engine 606, the reference arm may include a different combination of elements. In another implementation of the OCT imaging system 100, the reference arm may be implemented in the scan head 102.

In another alternative implementation of the interferometry engine 106, it may be possible to use specularly reflected light from the front of the surface being imaged as the reference arm light, in a common mode type configuration. This would depend on the consistency of the amount of light reflected, and may need additional signal processing to compensate for variations in the reference light. This configuration will probably work best for a perpendicular (or as perpendicular as possible) light beam since this will allow maximum capture of the specularly reflected light. In this configuration, an image of the anterior segment of an eye will be flat (compared to the almost flat image in FIG. 5), since the front surface of the cornea will always be the zero pathlength difference point and all other depths in the cornea will be referenced to the front surface. In this case the reference arm in the interferometry engine 106 would not be needed. Thus, it may be advantageous to replace the fiber coupler 622 with a three port circulator, with the input port connected to the light source 624, the common port connected to the sample arm, and the output port connected to the spectrometer 620.

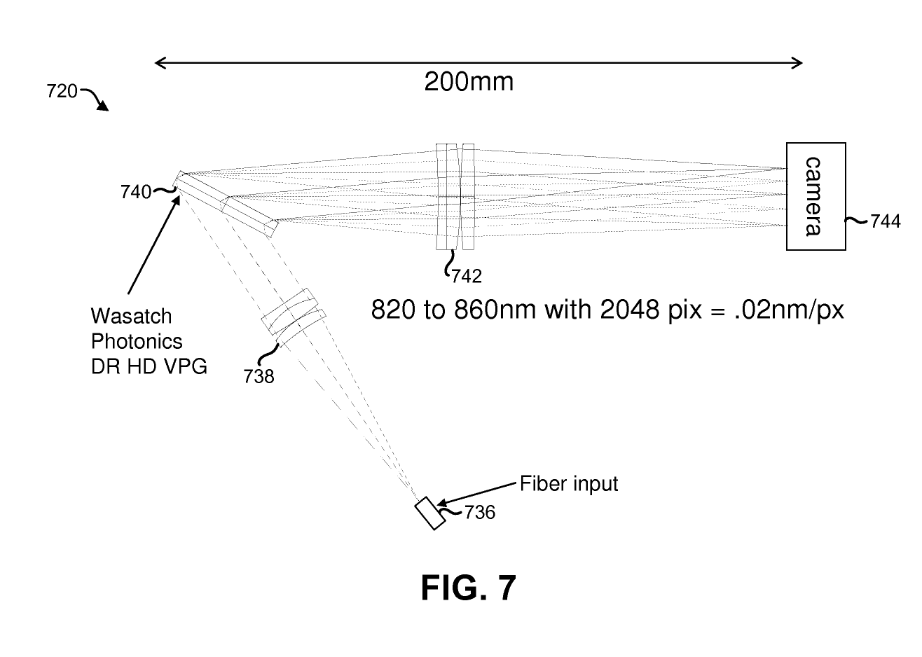

FIG. 7 illustrates a spectrometer 720 that is an implementation of the spectrometer 620 in the interferometry engine 606 shown in FIG. 6. The spectrometer 720 has a very high resolution and provides ultra-deep imaging. A beam from a fiber input 736 is collimated by an input lens set 738. The collimated beam is incident on a volume phase grating 740 at a relatively high angle of incidence. The beams exiting the volume phase grating 740 are focused on a camera 744 by an output lens set 742. Data from the camera 744 may be processed by the computer 108 in order to generate and display images (e.g., via the user interface 110). Alternatively, some processing may occur in the interferometry engine 106.

Spectrometers used in typical retinal scanners have a resolution on the camera of about 0.04 nm/pixel. This provides in OCT imaging depth in air of about 4.3 mm and about 3.1 mm in tissue. While sufficient for some applications (e.g., OCT imaging of the retina), this is inadequate for other applications (e.g., full depth imaging of the anterior segment).

The spectrometer 720 may have a resolution on the camera 744 of less than 0.02 nm/pixel, and may go to 0.01 nm/pixel or lower. In order to achieve this resolution in a reasonably sized mechanical package, the volume phase grating 740 may be a multiple reflection, high dispersion volume phase grating or a high dispersion volume phase grating sold by Wasatch Photonics. These volume phase gratings may have line spacings of 2100 lines/nm or higher. This provides very accurate, very high dispersion, enabling construction of a high resolution spectrometer in a package that is reasonably sized (e.g., about 20 to 30 centimeters long by 10 to 20 centimeters wide). In addition, these gratings have very high efficiency and low polarization dependent loss, which are very advantageous for spectrometers for OCT.

Building a spectrometer with this level of resolution using other grating line spacings or technologies may require very long optical path lengths resulting in spectrometers that might be 50 centimeters or more in length. The rigidity required to maintain the optical alignment of a few tens of microns over these distances over the operational temperature range to 20 to 30 degrees Celsius requires either lots of metal, with the associated cost and weight, or an automatic alignment mechanism with the associated cost and complexity. The size and number of optical elements increases the difficulty of maintaining high optical throughput over all wavelengths and environmental conditions. Furthermore, the time and cost to build a spectrometer scale with the size, so a spectrometer that utilizes a DR HD volume phase grating sold by Wasatch Photonics may be simpler and cheaper to build than a spectrometer based on other technologies. However, it is not necessary that the volume phase grating 740 is a DR HD volume phase grating sold by Wasatch Photonics.

In one example, the camera 744 may have 2048 pixels with a wavelength range of 40 nm. This may provide a resolution on the camera 744 of approximately 0.02 nm/pixel, which corresponds to an imaging depth of approximately 8.6 mm in air or approximately 6.2 mm in tissue. The 3 dB bandwidth of the source may be limited to approximately 25 nm, providing an axial resolution of approximately 12 microns in air or approximately 9 microns in tissue.

As another example, the camera 744 may have 4096 pixels with a wavelength range of approximately 70 nm. This may provide a resolution on the camera 744 of approximately 0.017 nm/pixel, which corresponds to an imaging depth of approximately 10.1 mm in air and 7.3 mm in tissue. Because in this example the spectrometer 720 covers 70 nm, the light source 624 could have a 3 dB bandwidth of approximately 45 nm, providing an axial resolution of approximately 7 microns in air and approximately 5 microns in tissue.

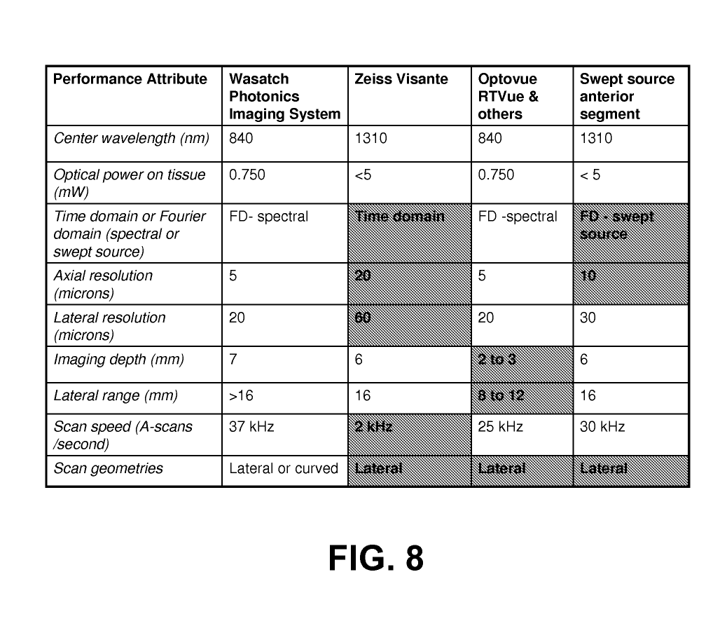

FIG. 8 shows some of the attributes of an OCT imaging system in accordance with an embodiment of the invention compared with time domain OCT systems, modified Fourier domain retinal imaging systems, and Fourier domain swept source systems. Boxes with a gray background represent attributes that are inferior to the embodiment under consideration. In FIG. 8, all depths and resolution values are in tissue, not in air.

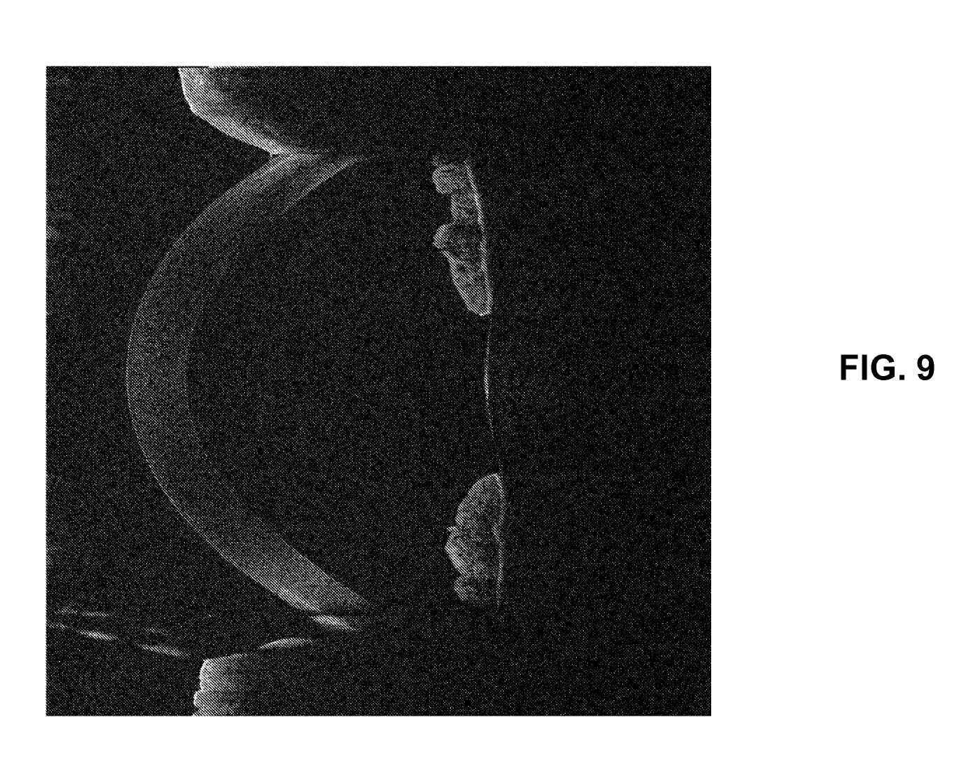

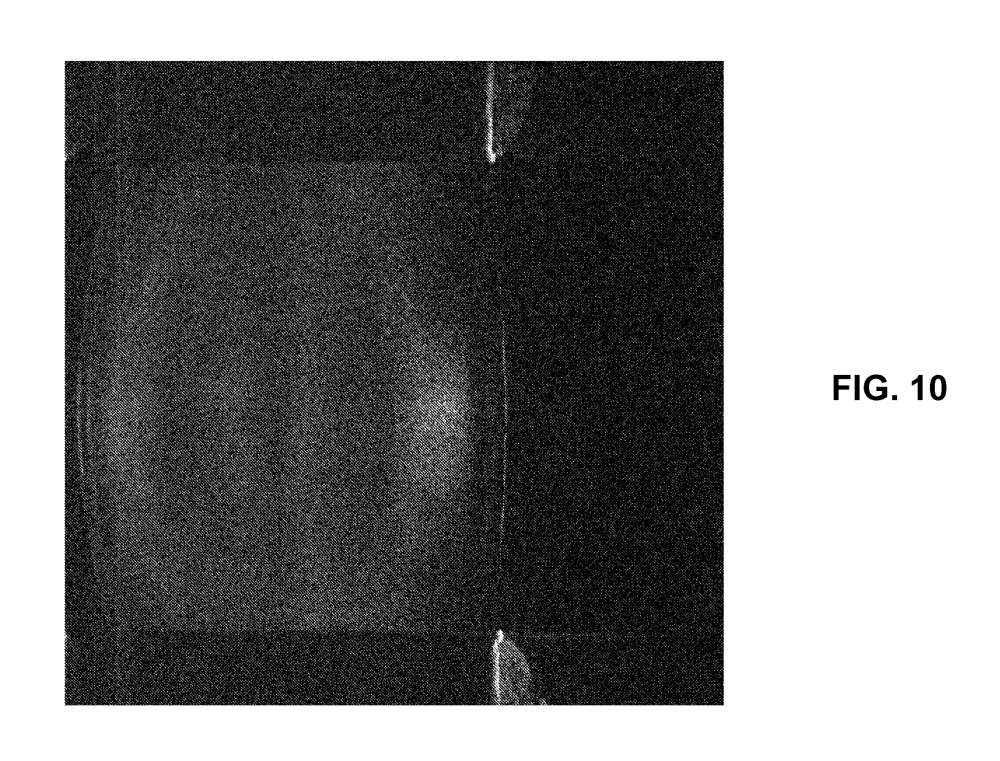

FIG. 9 illustrates an image of a human cornea that was taken by an OCT imaging system in accordance with an embodiment of the invention. FIG. 10 illustrates an image of an entire human lens that was taken by an OCT imaging system in accordance with an embodiment of the invention.

Although some embodiments of the present invention have been described in terms of imaging the anterior segment of the eye, there are numerous other applications where the disclosed OCT imaging system will have advantages. Eye imaging has focused on human eyes, but this system will work for other eyes as well, including human infants and animals, including pigs, birds, rats, mice, rabbits, dogs, cats, horses, cows, and others. For curved scanning there may be variations on the curved scanning optics so that the curvature of the surface normal to the scanning beam matches or closely matches the curvature of the front of the cornea of the target animal. For example, rats have a much smaller eye, requiring a much tighter radius of curvature for the curved scan.

There are numerous industrial and research applications that may need either the ultra-deep imaging and/or the curved scanning. Glass, plastic and other materials and combinations thereof may use the ultra-deep imaging for design, quality control, process control or other applications. Curved scanning may be advantageous for curved targets such as glass pipets, plastic tubing, and other samples.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An optical coherence tomography (OCT) imaging system, comprising:
a scan head;
lateral scan optics and curved scan optics that are interchangeably connectable to the scan head;
an interferometry engine that is based on spectral domain interferometry, wherein the interferometry engine comprises a spectrometer that is configured for ultra deep imaging; and
a computer.

2. The OCT imaging system of claim 1, wherein:
the scan head and the lateral scan optics facilitate lateral scanning; and
the lateral scanning comprises moving a focused beam back and forth in a direction that is perpendicular to the beam.

3. The OCT imaging system of claim 1, wherein:
the scan head and the curved scan optics facilitate curved scanning; and
the curved scanning comprises moving a beam across a curved surface such that the beam remains perpendicular or close to perpendicular relative to the curved surface.

4. The OCT imaging system of claim 1, wherein:
the low coherence interferometry engine comprises a fiber coupler;
the fiber coupler comprises a first port that is connected to a light source;
the fiber coupler further comprises a second port that is connected to the spectrometer;
the fiber coupler further comprises a third port that is connected to a sample arm via a connection to the scan head; and
the fiber coupler further comprises a fourth port that is connected to a reference arm.

5. The OCT imaging system of claim 4, wherein the reference arm comprises:
an optical attenuator;
a polarization controller;
a pathlength adjustment mechanism; and
a mirror.

6. The OCT imaging system of claim 1, wherein the ultra-deep spectrometer comprises:
a fiber input;
an input lens set;
a volume phase grating, wherein the input lens set collimates beams from the fiber input toward the volume phase grating;
an output lens set; and
a camera, wherein the output lens set focuses beams exiting the volume phase grating onto the camera.

7. The OCT imaging system of claim 1, further comprising a computer, wherein:
the spectrometer comprises a camera;
the computer is configured to process data from a camera within the spectrometer, generate images, and display images.

8. The OCT imaging system of claim 1, wherein the scan head comprises a sensor that automatically detects which one of the lateral scan optics and the curved scan optics is connected to the scan head.
